(19) United States
(12) Patent Application Publication
(10) Pub. No.: US 2025/0222393 A1
(43) Pub. Date: Jul. 10, 2025

(54) LIQUID DESICCANT REGENERATION SYSTEMS AND METHODS INCLUDING AIR DIFFUSER

(71) Applicant: Copeland LP, Sidney, OH (US)

(72) Inventor: Joseph H. Amend, IV, Yellow Springs, OH (US)

(21) Appl. No.: 18/409,327

(22) Filed: Jan. 10, 2024

(51) Int. Cl. B01D 53/14; B01D 53/18; B01D 53/26; F24F 3/14

(52) U.S. Cl. CPC B01D 53/1425; B01D 53/18; B01D 53/263; F24F 3/1417; B01D 2257/80; B01D 2258/06; F24F 2003/1458

(57) ABSTRACT

A liquid desiccant regeneration system includes a regeneration tank for containing saturated liquid desiccant and an air diffuser. The regeneration tank has an air inlet, a desiccant inlet, and a desiccant outlet. The air diffuser is positioned within the regeneration tank between the desiccant inlet and the desiccant outlet. The air diffuser is operable to receive an air stream from the air inlet and diffuse the air stream into the saturated liquid desiccant contained in the regeneration tank.

### FIELD

The field relates generally to heating, ventilation, and air conditioning (HVAC) systems, and more particularly, to HVAC systems and methods that include a liquid desiccant dehumidification sub-system and a liquid desiccant regeneration sub-system.

### BACKGROUND

Heating, ventilation, and air conditioning (HVAC) systems are known for their heating, cooling, and moisture removal capabilities for treating outside air that is circulated through an indoor space. The vapor compression cycle is widely used in HVAC systems to regulate the temperature and humidity of the outside air. Typically, outside air is cooled below its dew point temperature to allow moisture in the air to condense on an evaporator coil, thus dehumidifying the air. Since this process often leaves the dehumidified air at an uncomfortably cold temperature, the air is then reheated to a temperature more comfortable to a user. The process of overcooling and reheating the air can become very energy-intensive and costly.

In some applications, HVAC systems include a vapor compression system used in combination with a liquid desiccant dehumidification system to remove moisture from the outside air without cooling it below its dew point temperature. For example, HVAC systems may include a refrigerant sub-system that operates under the vapor compression cycle and an air treatment sub-system that uses heat transfer fluid and liquid desiccant to simultaneously absorb heat (sensible cooling) and moisture (latent cooling) from warm outside air to produce cooled and dehumidified indoor air. The air treatment sub-system may include three-way heat transfer equipment that facilitates sensible and latent cooling of the warm outdoor air using the heat transfer fluid and the liquid desiccant.

In operation of a three-way heat exchanger, the liquid desiccant and heat transfer fluid are channeled through the heat exchanger and heat is transferred between the liquid desiccant and the heat transfer fluid. An outdoor air stream is directed through the heat exchanger, and heat transfer fluid absorbs heat from the air stream while the liquid desiccant absorbs moisture from the air stream. The liquid desiccant may circulate between the three-way heat exchanger and a regeneration system, in which diluted liquid desiccant rejects the absorbed moisture into a sacrificial fluid. The refrigerant sub-system interfaces with the air treatment sub-system, whereby refrigerant in an evaporation stage of the vapor compression cycle absorbs heat from the heat transfer fluid in the three-way heat exchanger. The refrigerant is then channeled to a condensing stage in which the refrigerant rejects the absorbed heat into another fluid. Liquid desiccant treated by the regeneration system and heat transfer fluid treated by the refrigerant sub-system is then channeled back toward the three-way heat exchanger to again provide sensible and latent cooling of outside air.

Regeneration systems used to transfer moisture from diluted liquid desiccant and produce concentrated liquid desiccant may be expensive, inefficient in operation or with respect to energy usage, and/or have a relatively large footprint. A need exists for liquid desiccant regeneration systems that have a smaller footprint and greater location flexibility, facilitate reducing costs associated with manufacture, installation, and/or use, and otherwise facilitate improving efficiency of the HVAC system.

This background section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

### SUMMARY

One aspect is a liquid desiccant regeneration system. The liquid desiccant regeneration system includes a regeneration tank for containing saturated liquid desiccant and an air diffuser. The regeneration tank has an air inlet, a desiccant inlet, and a desiccant outlet. The air diffuser is positioned within the regeneration tank between the desiccant inlet and the desiccant outlet. The air diffuser is operable to receive an air stream from the air inlet and diffuse the air stream into the saturated liquid desiccant contained in the regeneration tank.

Another aspect is a heating, ventilation, and air conditioning (HVAC) system. The HVAC system includes a dehumidification sub-system operable to transfer moisture between a liquid desiccant and a first air stream and a regeneration sub-system operable to transfer moisture between the liquid desiccant and a second air stream. The HVAC system is operable to circulate concentrated liquid desiccant to the dehumidification sub-system and saturated liquid desiccant to the regeneration sub-system. The regeneration sub-system includes a regeneration tank for containing the saturated liquid desiccant and an air diffuser. The regeneration tank has an air inlet, a desiccant inlet, and a desiccant outlet. The air diffuser is positioned within the regeneration tank between the desiccant inlet and the desiccant outlet, wherein the air diffuser is operable to receive the second air stream from the air inlet and diffuse the second air stream into the saturated liquid desiccant contained in the regeneration tank.

Another aspect is a method of operating a liquid desiccant regeneration system. The method includes collecting saturated liquid desiccant in a regeneration tank; supplying an air stream to an air diffuser positioned in the regeneration tank; and diffusing the air stream into the saturated liquid desiccant collected in the regeneration tank using the air diffuser such that the diffused air stream absorbs moisture from the saturated liquid desiccant.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated embodiments may be incorporated into any of the above-described aspects, alone or in any combination.

### BRIEF DESCRIPTION OF THE DRAWINGS

FIG. 1 is a schematic flow diagram of a heating, ventilation, and air conditioning (HVAC) system.

FIG. 2 is a schematic flow diagram of another HVAC system.

FIG. 3 is a schematic of an example liquid desiccant regeneration system that may be used in the HVAC systems of FIGS. 1 and 2, and includes a regeneration tank and an air diffuser.

FIG. 4 is a first example of an air diffuser for use in the liquid desiccant regeneration system of FIG. 3.

FIG. 5 is a second example of an air diffuser for use in the liquid desiccant regeneration system of FIG. 3.

FIG. 6 is a third example of an air diffuser for use in the liquid desiccant regeneration system of FIG. 3.

FIG. 7 is an example method of operating a liquid desiccant regeneration system.

Corresponding reference characters indicate corresponding parts throughout the drawings.

### DETAILED DESCRIPTION

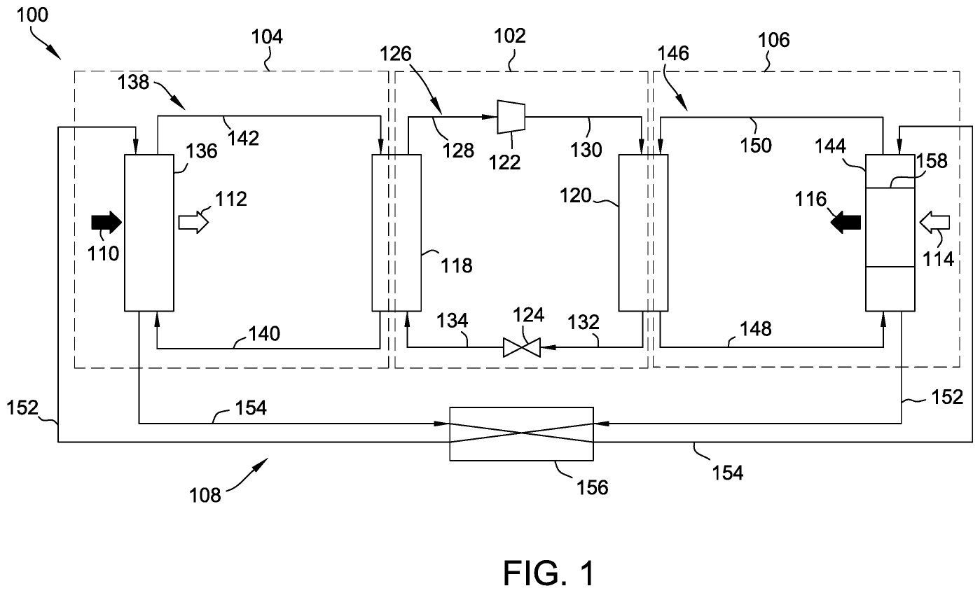

FIG. 1 is a schematic diagram of a heating, ventilation, and air conditioning (HVAC) system 100. The HVAC system 100 includes sub-systems 102-106 and a liquid desiccant circuit 108 which facilitate the heating, cooling, and moisture removal capabilities of the system 100. The sub-systems of the HVAC system 100 include a refrigerant sub-system 102, a conditioner (or dehumidification) sub-system 104, and a regenerator (or regeneration) sub-system 106. The conditioner sub-system 104 and the regenerator sub-system 106 are usable to respectively treat first and second inlet air streams 110 and 114, and may be referred to herein as air treatment sub-systems 104 and 106. The HVAC system 100 may include additional components or other components than those shown and described with reference to FIG. 1.

In an example operating mode of the HVAC system 100, the conditioner sub-system 104 removes heat from the first inlet air stream 110 and channels a conditioned outlet air stream 112 to a conditioned space (not shown), such as an interior of a building structure or vehicle. The conditioned outlet air stream 112 exiting the conditioner sub-system 104 may have a lower temperature than the first inlet air stream 110. Heat removed from the first inlet air stream 110 is transferred from the conditioner sub-system 104 to the refrigerant sub-system 102. Heat transferred to the refrigerant sub-system 102 may be transferred to a sacrificial fluid (e.g., outdoor air) stream. Additionally and/or alternatively, heat from the refrigerant sub-system 102 may be transferred to the regenerator sub-system 106, which may transfer the heat into the second inlet air stream 114 and channels a heated outlet air stream 116 to the atmosphere.

The refrigerant sub-system 102 includes an evaporator 118, a condenser 120, a compressor 122, and an expansion valve 124. The compressor 122 may be any suitable compressor including, but not limited to, scroll, reciprocating, rotary, screw, and centrifugal compressors. The expansion valve 124 may be any suitable expansion valve, such as a thermal expansion valve. The expansion valve 124 may alternatively be any suitable expansion device, such as an orifice or capillary tube for example. The refrigerant sub-system 102 also includes a refrigerant loop 126 that circulates a working fluid, such as a refrigerant, between the evaporator 118, the compressor 122, the condenser 120, and the expansion valve 124. The refrigerant sub-system 102 may include additional components or other components than those shown and described with reference to FIG. 1.

In operation of the refrigerant sub-system 102, the refrigerant in the loop 126 is channeled as a low pressure gas refrigerant 128 toward the compressor 122. The compressor 122 compresses the gas refrigerant 128, which raises the temperature and pressure of the refrigerant. Pressurized, high temperature gas refrigerant 130 exits the compressor 122 and is channeled toward the condenser 120, where the high pressure gas refrigerant 130 is condensed to a high pressure liquid refrigerant 132. The liquid refrigerant 132 exiting the condenser 120 is channeled toward the expansion valve 124 that reduces the pressure of the liquid. The reduced pressure fluid refrigerant 134, which may be a gas or a mixture of gas and liquid after passing through the expansion valve 124, is then channeled toward the evaporator 118. The fluid refrigerant 134 evaporates to a gas in the evaporator 118, exiting the evaporator as the low pressure gas refrigerant 128. The gas refrigerant 128 is then channeled back toward the compressor 122, where the gas refrigerant 128 is again compressed and the process repeats. Circulation of the refrigerant in the loop 126 may be driven by the compressor 122, and, more particularly, by a pressure differential that exists between the pressurized, high temperature gas refrigerant 130 exiting the compressor 122 and the low pressure gas refrigerant 128 entering the compressor 122. The direction of flow of the refrigerant through the loop 126, as shown in FIG. 1, may be reversed to switch the heat transfer functions of the evaporator 118 and the condenser 120, and may enable the HVAC system 100 to operate in various operating modes.

The conditioner sub-system 104 includes a conditioner 136 (e.g., a three-way heat exchanger) and a conditioner heat transfer fluid loop 138 that circulates a conditioner heat transfer fluid (e.g., water, a glycol-based fluid, or any combination thereof) to and from the conditioner 136. Any suitable number of conditioners 136 (e.g., three-way heat exchangers) may be included in the conditioner sub-system 104. Where the conditioner sub-system 104 includes multiple conditioners 136, the conditioners may operate in series, in parallel, or any combination thereof.

Example three-way heat exchangers that may be used as the conditioner 136 are described in U.S. patent application Ser. No. 18/482,454, filed Oct. 6, 2023, U.S. patent application Ser. No. 18/490,984, filed Oct. 20, 2023, U.S. patent application Ser. No. ______ (Docket No. COP-23-049US01), titled “THREE-WAY HEAT EXCHANGE MODULE WITH CONTROLLED FLUID FLOW,” U.S. patent application Ser. No. 18/390,475, filed Dec. 20, 2023, U.S. patent application Ser. No. 18/390,941, filed Dec. 20, 2023, U.S. patent application Ser. No. 18/390,948, filed Dec. 20, 2023, and U.S. patent application Ser. No. 18/391,384, filed Dec. 20, 2023, the disclosures of which are incorporated by reference in their entirety.

The conditioner sub-system 104 interfaces with the refrigerant sub-system 102 via the evaporator 118. In particular, the evaporator 118 is included in the refrigerant loop 126 and the conditioner heat transfer loop 138, and facilitates transfer of heat from the conditioner heat transfer fluid in the loop 138 into the fluid refrigerant 134 in the refrigerant loop 126. The conditioner sub-system 104 may include additional components or other components than those shown and described with reference to FIG. 1. For example, the conditioner sub-system 104 may include one or more pumps (not shown) for circulating the conditioner heat transfer fluid in the loop 138 between the conditioner 136 and the evaporator 118. Suitable pumps that may be included in the conditioner sub-system 104 include, for example, centrifugal pumps, diaphragm pumps, positive displacement pumps, or any type of pump suitable for transferring liquid. The conditioner sub-system 104 may include additional heat transfer equipment that transfers heat from the conditioner heat transfer fluid into the atmosphere, or vice versa, depending on the operational requirements of the HVAC system 100 and other factors (e.g., a temperature and/or humidity of the first air inlet stream 110).

In operation of the conditioner sub-system 104, the conditioner heat transfer fluid in the loop 138 is channeled toward the evaporator 118. The conditioner heat transfer fluid is cooled in the evaporator 118 as heat is transferred from the conditioner heat transfer fluid into the fluid refrigerant 134 in the loop 126 to produce the gas refrigerant 128. Cooled conditioner heat transfer fluid 140 exiting the evaporator 118 is channeled toward and enters the conditioner 136. The first inlet air stream 110 is also directed through the conditioner 136. The conditioner 136 transfers heat from the first inlet air stream 110 into the conditioner heat transfer fluid 140, thus heating the conditioner heat transfer fluid. The heated conditioner heat transfer fluid 142 exiting the conditioner 136 is channeled back toward the evaporator 118 and the process repeats.

The regenerator sub-system 106 includes a regenerator 144 and a regenerator heat transfer fluid loop 146 that circulates a regenerator heat transfer fluid (e.g., water, a glycol-based fluid, or any combination thereof) to and from a heater 158 thermally connected to the regenerator 144. Any suitable number of regenerators 144 and/or heaters 158 may be included in the regenerator sub-system 106. Where the regenerator sub-system 106 includes multiple regenerators 144 and/or heaters 158, the regenerators or heaters may operate in series, in parallel, or any combination thereof. The heater 158 may include heating coils positioned in the regenerator 144 and/or a heating jacket surrounding the regenerator 144. In the example HVAC system 100, the regenerator sub-system 106 interfaces with the refrigerant sub-system 102 via the condenser 120. In particular, the condenser 120 is included in the refrigerant loop 126 and the regenerator heat transfer loop 146, and facilitates transfer of heat from the pressurized gas refrigerant 130 in the refrigerant loop 126 into the regenerator heat transfer fluid. The regenerator sub-system 106 may include additional components or other components than those shown and described with reference to FIG. 1. For example, the regenerator sub-system 106 may include one or more pumps (not shown) for circulating the regenerator heat transfer fluid in the loop 146 between the regenerator 144 and the condenser 120. Suitable pumps that may be included in the regenerator sub-system 106 include, for example, centrifugal pumps, diaphragm pumps, positive displacement pumps, or any type of pump suitable for transferring liquid. The regenerator sub-system 106 may include additional heat transfer equipment that transfers heat from the atmosphere into the regenerator heat transfer fluid, or vice versa, depending on the operational requirements of the HVAC system 100 and other factors (e.g., a temperature and/or humidity of the first air inlet stream 110).

In operation of the regenerator sub-system 106, the regenerator heat transfer fluid in the loop 146 is channeled toward the condenser 120. The regenerator heat transfer fluid is heated in the condenser 120 as heat is transferred from the pressurized gas refrigerant 130 in the loop 126 into the regenerator heat transfer fluid to produce the liquid refrigerant 132. Heated regenerator heat transfer fluid 148 exiting the condenser is channeled towards the regenerator 144 and into the heater 158. The second inlet air stream 114 is also directed through the regenerator 144. The heater 158 operates to transfer heat from the regenerator heat transfer fluid into the second inlet air stream 114, thus cooling the regenerator heat transfer fluid. The heated outlet air stream 116 exiting the regenerator 144 has a greater temperature than the second inlet air stream 114. The cooled regenerator heat transfer fluid 150 exiting the regenerator 144 is channeled back toward the condenser 120 and the process repeats.

The HVAC system 100 also includes the liquid desiccant circuit 108 that operates in conjunction with the sub-systems 102-106 to facilitate cooling the first inlet air stream 110 by latent and sensible cooling. The liquid desiccant circuit 108 includes a liquid desiccant that is channeled between the conditioner 136 and the regenerator 144. Suitable liquid desiccants that may be used in the liquid desiccant circuit 108 include, for example, desiccant salt solutions, such as solutions of water and lithium chloride (LiCl), lithium bromide (LiBr), calcium chloride (CaCl₂), or any combination thereof, triethylene glycol, sodium hydroxide, sulfuric acid, and so-called ionic liquid desiccants, or organic salts that are liquid at room temperature and have organic cations and organic or inorganic anions.

The liquid desiccant circuit 108 may include one or more pumps (not shown) for channeling the liquid desiccant between the conditioner 136 and the regenerator 144. Suitable pumps that may be included in the liquid desiccant circuit 108 include, for example, centrifugal pumps, diaphragm pumps, positive displacement pumps, or any type of pump suitable for transferring liquid. The liquid desiccant circuit 108 may include one or more pumps for transferring concentrated liquid desiccant 152 from the regenerator 144 toward the conditioner 136 and one or more pumps for transferring diluted (or saturated) liquid desiccant 154 from the conditioner 136 toward the regenerator 144.

Concentrated liquid desiccant 152 in the liquid desiccant circuit 108 is channeled toward the conditioner 136 of the conditioner sub-system 104, where the concentrated liquid desiccant 152 removes moisture from the first inlet air stream 110. The concentrated liquid desiccant 152 cooperates with the cooled conditioner heat transfer fluid 140 in the conditioner 136 to absorb heat and moisture from the first inlet air stream 110. The conditioned outlet air stream 112 exiting the conditioner 136 may have a lower humidity and/or a lower temperature than the first inlet air stream 110. The liquid desiccant, having absorbed moisture from the first inlet air stream 110, exits the conditioner 136 as diluted (or saturated) liquid desiccant 154.

The diluted (or saturated) liquid desiccant 154 is channeled toward the regenerator 144 of the regenerator sub-system 106, where the diluted liquid desiccant 154 rejects moisture into the second inlet air stream 114. The diluted liquid desiccant 154 cooperates with the heated regenerator heat transfer fluid 148 channeled to the heater 158 to reject heat and moisture into the second inlet air stream 114. The heated outlet air stream 116 exiting the regenerator 144 thus has a greater humidity as well as a higher temperature than the second inlet air stream 114. The liquid desiccant, having rejected moisture into the second inlet air stream 114, exits the regenerator sub-system 106 as concentrated liquid desiccant 152. The concentrated liquid desiccant 152 exiting the regenerator 144 is channeled back toward the conditioner 136, and the process repeats.

The liquid desiccant circuit 108 may also include a desiccant-desiccant heat exchanger 156 for transferring heat from the concentrated liquid desiccant 152 that has exited the regenerator 144 to the diluted (or saturated) liquid desiccant 154 that has exited the conditioner 136. The desiccant-desiccant heat exchanger 156 may facilitate improving the functions of the liquid desiccant in the conditioner 136 and the regenerator 144. For example, the desiccant-desiccant heat exchanger 156 may reduce a temperature of the concentrated liquid desiccant 152 to provide greater cooling and dehumidifying capabilities of the conditioner 136. Additionally and/or alternatively, the desiccant-desiccant heat exchanger 156 may increase a temperature of the diluted liquid desiccant 154 to enable the diluted liquid desiccant 154 to desorb a greater amount of moisture in the regenerator 144. The desiccant-desiccant heat exchanger 156 may be an inline heat exchanger or any suitable heat exchanger that facilitates direct heat transfer between the concentrated liquid desiccant 152 and the diluted liquid desiccant 154. The desiccant-desiccant heat exchanger 156 may alternatively facilitate indirect heat exchange between the concentrated liquid desiccant 152 and the diluted liquid desiccant 154, such as via a vapor compression heat pump. Auxiliary heating and cooling sources (e.g., heating and cooling fluid, such as water) may also be utilized, in addition to or in lieu of the heat exchanger 156, to respectively heat the diluted liquid desiccant 154 and cool the concentrated liquid desiccant 152. The liquid desiccant circuit 108 may include additional components or other components than those shown and described with reference to FIG. 1.

Thus, in the example operating mode of the HVAC system 100, sensible cooling of the first inlet air stream 110 is facilitated by the conditioner 136 of the conditioner sub-system 104, which transfers heat from the inlet air stream 110 into the conditioner heat transfer fluid. The heat removed from the first inlet air stream 110 is then transferred sequentially between the sub-systems 104, 102, and 106 via the evaporator 118 and the condenser 120, and eventually is rejected into the second inlet air stream 114 via the regenerator 144. Latent cooling of the first inlet air stream 110 is also facilitated by the conditioner 136, which removes moisture from the inlet air stream 110 using the concentrated liquid desiccant 152. The moisture absorbed by the diluted (or saturated) liquid desiccant 154 is desorbed in the regenerator 144 into the second inlet air stream 114, which regenerates the concentrated liquid desiccant 152 that is then channeled back toward the conditioner 136.

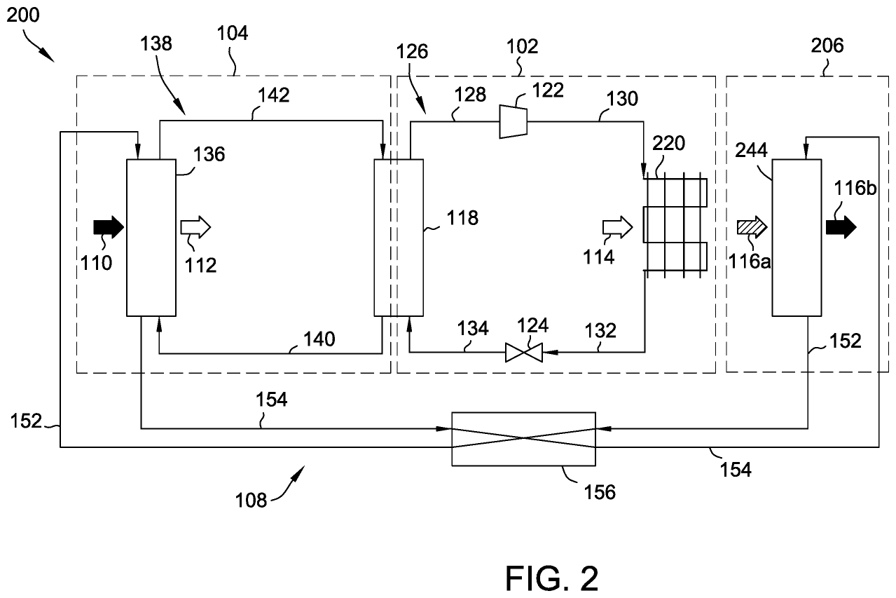

FIG. 2 is another example HVAC system 200 that includes the conditioner sub-system 102, the refrigerant sub-system 104, and the liquid desiccant circuit 108 described above for the HVAC system 100. Corresponding reference numerals in FIGS. 1 and 2 indicate corresponding parts between the HVAC systems 100 and 200. The HVAC system 200 also includes a regenerator sub-system 206 that, similar to the regenerator sub-system 106 of the HVAC system 100, includes a regenerator 244 that facilitates the diluted (or saturated) liquid desiccant 154 rejecting moisture to produce the concentrated liquid desiccant 152. In this example, the regenerator sub-system 206 does not include a regenerator heat transfer fluid loop that interfaces with the refrigerant sub-system 102. A condenser 220 of the refrigerant sub-system 102 includes condenser coils across which the second inlet air stream 114 flows before entering the regenerator 244. The second inlet air stream 114 is heated by the condenser 220, producing a heated, dry air stream 116a that is subsequently channeled to the regenerator 244. The heated, dry air stream 116a absorbs moisture from the saturated liquid desiccant 152 in the regenerator 244, and exits as a humid air stream 116b.

In the example HVAC systems 100 and 200, heat is suitably supplied to the regenerator 106 or 206, the second inlet air stream 114, and/or the saturated liquid desiccant 154 such that a vapor pressure differential exists between the saturated liquid desiccant and the second inlet air stream in the regenerator 144 or 244. When the saturated liquid desiccant is heated, either before or within the regenerator 144 or 244, its vapor pressure increases above that of the second inlet air stream 114 or 116a which allows the moisture to be transferred to the inlet air stream 114 or 116a. The illustrated HVAC systems 100 and 200 depict two example heating mechanisms of achieving the desired increase in the vapor pressure differential between the saturated liquid desiccant and the second inlet air stream in the regenerator 144 or 244. These mechanisms could also be utilized in combination. In other examples, the second inlet air stream 114 and/or the saturated liquid desiccant 154 may be heated using any suitable additional and/or alternative means. For example, the second inlet air stream 114 and/or the saturated liquid desiccant 154 may be heated using a heater thermally connected to the regenerator 144 or 244 (e.g., the heater 158 shown in FIG. 1), a condenser fan (e.g., the condenser coils 220 shown in FIG. 2), an inline heater (e.g., the heat exchanger 156 shown in FIGS. 1 and 2), or another auxiliary heater such as a boiler, a central hot water source, a waste heat source, and/or a hot water heater. Any combination or sub-combination of the described heating mechanisms for increasing the vapor differential between the saturated liquid desiccant and the second inlet air stream may be implemented.

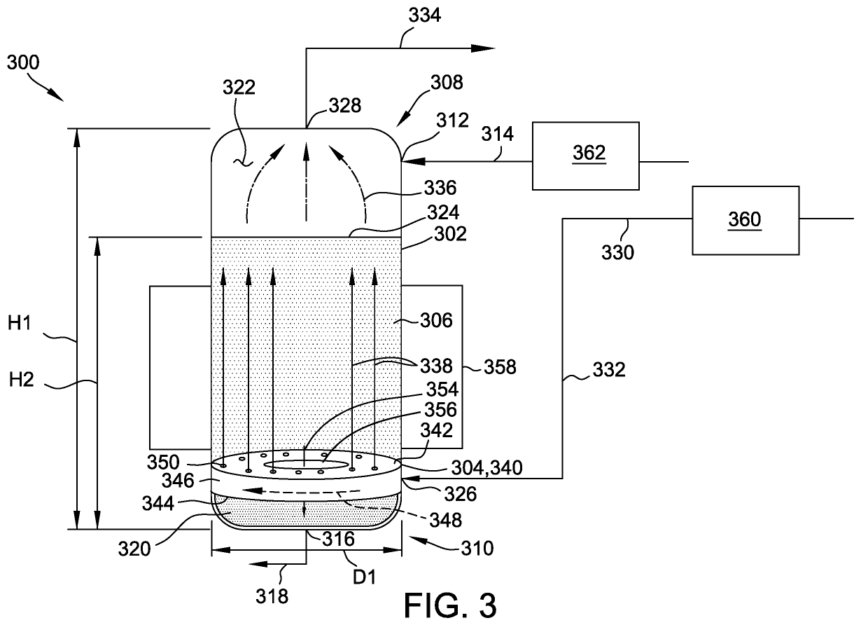

FIG. 3 is a schematic of a liquid desiccant regeneration system 300 that may be used as the regenerator sub-system 106 in FIG. 1 and/or the regenerator sub-system 206 in FIG. 2. The system 300 includes a regeneration tank 302 and an air diffuser 304 that cooperate to facilitate desorbing moisture from saturated liquid desiccant 306 contained in the regeneration tank 302 into an inlet air stream 332. The regeneration tank 302 and the air diffuser 304 may be implemented as the regenerator 144 in FIG. 1 and/or the regenerator 244 in FIG. 2. Any suitable number of regeneration tanks 302 and air diffusers 304 may be included in the liquid desiccant regeneration system 300, and multiple regeneration tanks and air diffusers may operate in series, in parallel, or any combination thereof.

The regeneration tank 302 is suitably sized and shaped for containing a volume of the saturated liquid desiccant 306. The regeneration tank 302 has a tank height H₁ measured between vertical ends 308, 310 (also referred to as a top end 308 and a bottom end 310). The regeneration tank 302 also has a tank width or tank diameter D₁ measured across the tank perpendicular to the tank height H₁. The saturated liquid desiccant 306 is collected in (or enters) the regeneration tank 302 via a desiccant inlet 312. The desiccant inlet 312 may be defined by a desiccant inlet fitting (not shown) located on the regeneration tank 302 proximate the first top end 308. The desiccant inlet 312 is connected (e.g., via the desiccant inlet fitting) to a saturated desiccant line 314 of a liquid desiccant circuit, such as the liquid desiccant circuit 108 in FIGS. 1 and 2. The saturated liquid desiccant 306 may be channeled to the regeneration tank 302 via the saturated desiccant line 314 from another air treatment system operated in conjunction with the liquid desiccant regeneration system 300, such as a liquid desiccant dehumidification system (e.g., the conditioner sub-system 104 in FIGS. 1 and 2). The regeneration tank 302 also includes a desiccant outlet 316, which may be defined by a desiccant outlet fitting (not shown) located on the regeneration tank proximate the bottom end 310. The desiccant outlet 316 is connected (e.g., via the desiccant outlet fitting) to a concentrated desiccant line 318 of a liquid desiccant circuit, such as the liquid desiccant circuit 108 in FIGS. 1 and 2. Concentrated liquid desiccant 320 exiting the regeneration tank 302 via the desiccant outlet 316 may be channeled via the concentrated desiccant line 318 back to the liquid desiccant dehumidification system (e.g., the conditioner sub-system 104 in FIGS. 1 and 2).

In operation of the regeneration system 300, the saturated liquid desiccant 306 contained in the regeneration tank 302 (and any concentrated liquid desiccant 320 remaining in the regeneration tank prior to exiting via the desiccant outlet 316) defines a desiccant level height H₂ measured from the bottom end 310 of the tank 302. The desiccant level height H₂ may be shorter than the tank height H₁ such that an air flow clearance 322 is defined in the regeneration tank 302 between a top surface 324 of the saturated liquid desiccant 306 and the top end 308. Flow of the saturated liquid desiccant 306 and concentrated liquid desiccant 320 respectively entering and exiting the regeneration tank 302 may be controlled such that a substantially constant desiccant level height H₂ is maintained in the regeneration tank 302 during operation. For example, the desiccant level height H₂ may be maintained in a range of #10%, +5%, or +1% of an average desiccant level height H₂.

The regeneration tank 302 also includes an air inlet 326 and an air outlet 328. The air inlet 326 may be defined by an air inlet fitting (not shown) located on the regeneration tank proximate the bottom end 310. The air outlet 328 may be defined by an air outlet fitting (not shown) located on the regeneration tank proximate the top end 308. The air inlet 326 is connected (e.g., via the air inlet fitting) to an inlet air supply line 330. An inlet air stream 332 is channeled towards the regeneration tank 302 via the inlet air supply line 330 and enters the regeneration tank 302 via the air inlet 326. The inlet air stream 332 is suitably dry air capable of absorbing moisture from the saturated liquid desiccant 306 contained in the regeneration tank 302. The inlet air stream 332 may optionally be heated upstream from the air inlet 326 (e.g., using a condenser fan, an inline heater, or another auxiliary heat source such as a boiler, a central hot water source, a waste heat source, and/or a hot water heater). As illustrated in FIG. 3, a portion of the inlet air supply line 330 is suitably positioned vertically above the desiccant level height H₂, which may facilitate reducing or eliminating the propensity for a back flow of liquid desiccant from the regeneration tank 302 to enter the inlet air supply line 332. The air outlet 328 is connected (e.g., via the air outlet fitting) to an outlet air line 334 that channels an outlet air stream 336 exiting the regeneration tank 302 via the air outlet. The air outlet 328 may be positioned adjacent the air flow clearance 322 defined in the regeneration tank 302. The outlet air stream 334 has a greater humidity than the inlet air stream 332, having absorbed moisture from the saturated liquid desiccant 306 contained in the regeneration tank 302 to produce the concentrated liquid desiccant 320.

The air diffuser 304 is positioned within the regeneration tank 302 and is submerged in the saturated liquid desiccant 306 contained in the regeneration tank 302. Alternatively stated, the air diffuser 304 is positioned in the regeneration tank 302 proximate the bottom end 310 and below the desiccant level height H₂. The air diffuser 304 is connected to the air inlet 326 and receives the inlet air stream 332 entering the regeneration tank 302. The air diffuser 304 operates to diffuse the inlet air stream 332 into the volume of saturated liquid desiccant 306 contained in the regeneration tank 302. The diffused air stream is indicated by the flow lines 338 in FIG. 3. The diffused air stream 338 constitutes air bubbles that are distributed throughout the volume of saturated liquid desiccant 306 and flow vertically upward through the saturated liquid desiccant towards the air flow clearance 322. The diffused air stream 338 suitably provides a large amount of surface area contact with the saturated liquid desiccant 306, which facilitates optimizing the amount of moisture absorbed from the saturated liquid desiccant. The diffused air stream 338 flows through the surface 324 of the volume of saturated liquid desiccant, forming the outlet air stream 336 in the air flow clearance 322 that subsequently exits the regeneration tank 302 via the air outlet 328.

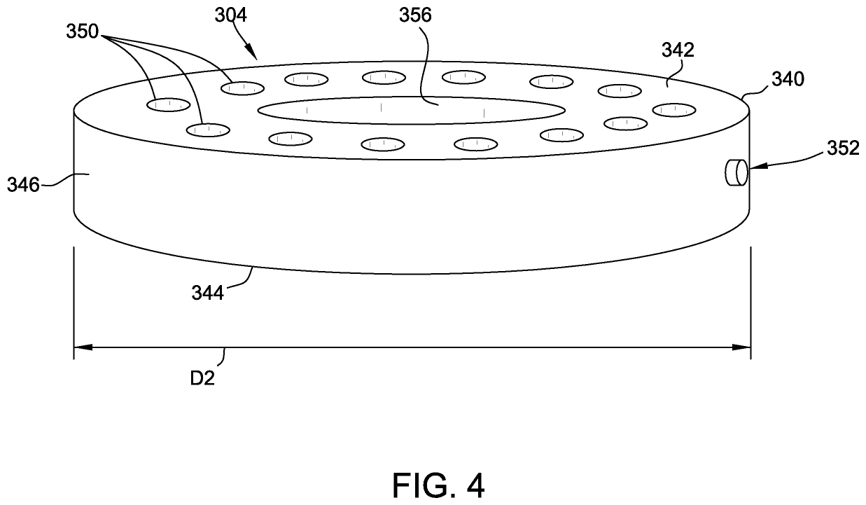

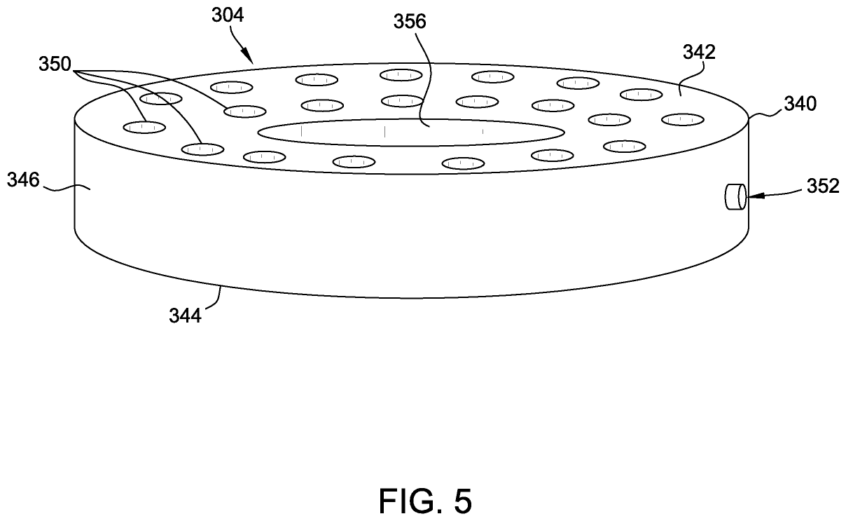

With additional reference to FIGS. 4 and 5, the air diffuser 302 has a diffuser body 340 that is suitably sized and shaped for positioning in the regeneration tank 302. In the example of FIG. 3, the regeneration tank 302 has a circular cross-section defining the diameter D₁. The diffuser body 340 has an annular shape in this example, with opposing radial surfaces 342, 344 and a circumferential edge 346 extending between the radial surfaces 342, 344. The circumferential edge 346 defines an outer diameter D₂ (FIG. 4) of the diffuser body 340 that is smaller than or substantially equal to the diameter D₁. The outer diameter D₂ of the diffuser body 340 may be such that the diffuser body is positioned and retained in the regeneration tank 302 by press fit between an inner wall of the regeneration tank 302 and the circumferential edge 346 of the diffuser body 340. The diffuser body 340 may be retained in the regeneration tank 302 by any suitable means in other examples. The size and shape of the diffuser body 340 may vary depending on the size and shape of the regeneration tank 302.

The diffuser body 340 includes an interior volume that defines an air channel (indicated by the flow line 348 in FIG. 3) for circulating the inlet air stream 332. An air flow opening 352 may be defined in diffuser body 340, for example, on the circumferential edge 346 (as shown in FIG. 4) and/or one of the radial surfaces 342, 344. The air flow opening 352 may be directly or indirectly connected to the air inlet 326 of the regeneration tank 302 and allows the inlet air stream 332 to enter the air channel 348.

The air diffuser 304 also includes outlet ports 350 defined in the diffuser body 340. The outlet ports 350 are sized, shaped, and positioned to diffuse the inlet air stream 332 circulating through the air channel 348 into the saturated liquid desiccant 306, producing the diffused air stream 338. The outlet ports 350 may be a series of small holes positioned on the radial surface 342 that faces the top end 308 of the regeneration tank 302. The outlet ports 350 may have any suitable arrangement to facilitate diffusing (distributing) the diffused air stream 338 in the saturated liquid desiccant 306. For example, the outlet ports 350 may be arranged in a circular pattern (FIGS. 3 and 4) or a spiral pattern (FIG. 5) on the radial surface 342. In some examples, the outlet ports 350 may additionally and/or alternatively be located on the circumferential edge 346 and/or the radial surface 344 that faces the bottom end 310 of the regeneration tank 302. The outlet ports 350 may each have the same shape and/or size, or a shape and/or size of the outlet ports 350 may vary. For example, the outlet ports 350 may have the same cross-sectional size and/or shape, or the outlet ports 350 may have different cross-sectional sizes and/or shapes. Additionally and/or alternatively, the outlet ports 350 may have the same or different geometrical shape. The outlet ports 350 may have any suitable geometric shape, such as, for example, prismatic (e.g., cylindrical), bell-shaped, conical, parabolic, and other shapes.

The outlet ports 350 may be sized, shaped, and positioned to control (e.g., generate) turbulence in the diffused air stream 338. Turbulent flow may enhance contact and moisture transfer between the diffused air stream 338 and the saturated liquid desiccant 306. For example, the outlet ports 350 may be formed at angles in the radial surface 342 such that the diffused air stream 338 has a controlled flow path in the saturated liquid desiccant 306 for generating turbulent flow. The outlet ports 350 may be orientated at similar angles to create a series of harmonized flow paths (e.g., multiple helical flow paths) of the diffused air stream 338. Alternatively, the outlet ports 350 may oriented at different angles to create chaotic flow paths of the diffused air stream 338. Additionally and/or alternatively, one, some, or all the outlet ports 350 may include a nozzle that controls an entry angle from the respective outlet port 350 for controlling the flow path(s) of the diffused air stream 338. Turbulent flow may additionally and/or alternatively be generated in the diffused air stream 338 using other mechanisms, for example, by rotating the air diffuser 304 within the regeneration tank 302 and/or using mixing elements (e.g., impellers or baffles) in the regeneration tank 302.

The diffuser body 340 is positioned in the regenerator tank 302 between the desiccant inlet 312 and the desiccant outlet 316 and defines a desiccant flow path (indicated by the flow line 354 in FIG. 3). Saturated liquid desiccant 306 that has desorbed moisture into the diffused air stream 338, thus producing concentrated liquid desiccant 320, flows through the desiccant flow path 354 towards the desiccant outlet 316. In the illustrated example, the saturated liquid desiccant 306 flows vertically downward in the regeneration tank 302, counter or opposite the diffused air stream 338 that flows vertically upward towards the air flow clearance 322, and the concentrated liquid desiccant 320 continues to flow vertically downward through the desiccant flow path 354. In the examples shown in FIGS. 3-5, the diffuser body 340 includes a central passage 356 extending through the radial surfaces 342, 344, and the central passage 356 forms the desiccant flow path 354. The outlet ports 350 may be in the circular pattern (FIGS. 3 and 4) or the spiral pattern (FIG. 5) on the radial surface 342 about the central passage 356. In other examples, the diffuser body 340 may additionally and/or alternatively include multiple passages that form discrete portions of the desiccant flow path 354. For example, the diffuser body 340 may, in addition to or alternatively to the central passage 356, include passages located radially outward (e.g., proximate the circumferential edge 346) that form discrete portions of the desiccant flow path 354.

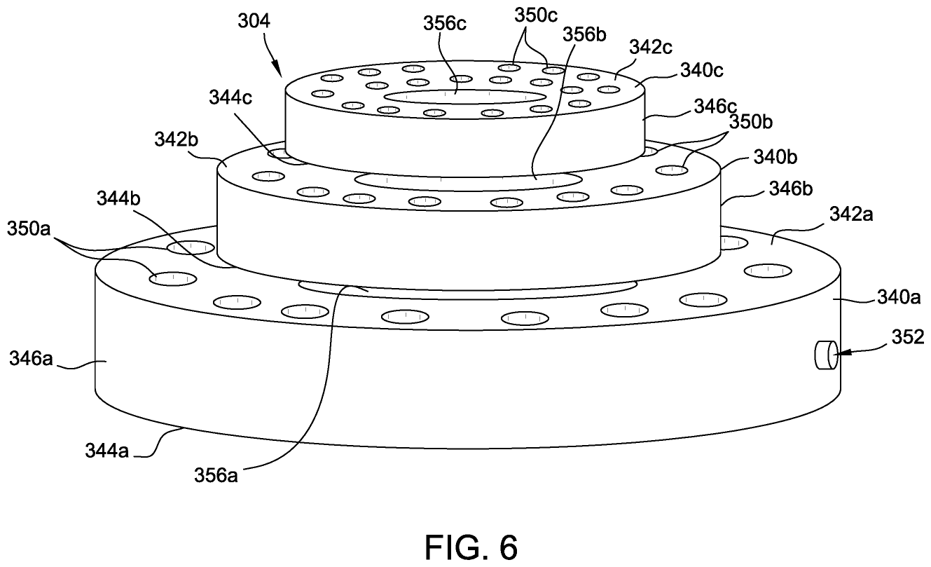

FIG. 6 is an alternative example of the air diffuser 304 in which the air diffuser 304 includes multiple (e.g., three) body portions 340a-340c. Any number of body portions may be included in this example, such as two body portions or more than two body portions. Each body portion 340a-340c may have a similar configuration as the diffuser body 340 described above with reference to FIGS. 3-5. Reference numerals for each body portion 340a-340c in FIG. 6 corresponding to reference numerals used for the diffuser body 340 in FIGS. 3-5 indicate corresponding parts. The body portions 340a-340c are similarly shaped and gradually decrease in size such that the air diffuser 304 has a tapered width or diameter. In the illustrated example, each body portion 340a-340c, like the diffuser body 340, is annular in shape, and includes radial surfaces 342a-342c, 344a-344c, a circumferential edge 346a-346c, and a central passage 356a-356c. The body portions 340a-340c may be axially aligned along the central passages 356a-356c. The body portions 340a-340c are also spaced apart axially such that a clearance is defined between adjacent body portions 340a-340c, providing radial access to the axially aligned central passages 356a-356c.

A first body portion 340a, which may also be referred to as a bottom body portion 340a, is largest in size (diameter). When the body portions 340a-340c are positioned in the regeneration tank 302, the bottom body portion 340a is located proximate the bottom end 310. The body portions 340b and 340c successively reduce in size (diameter), such that the size (diameter) of the air diffuser 304 tapers towards the top end 308 when positioned in the regeneration tank 302. The radial surface 342a of the bottom body portion 340a extends radially outward beyond the circumferential edge 346b of a second or “middle” body portion 340b. The radial surface 342b of the middle body portion 340b extends radially outward beyond the circumferential edge 346a of a third or “top” body portion 346a.

The spaced apart body portions 340a-340c may be connected to define a single air channel 348 (shown in FIG. 3) for circulating the inlet air stream 332, as described above for the diffuser body 340. For example, adjacent body portions 340a-340c may be fluidly connected by conduits or pipes (not shown) extending therebetween. A single air flow opening 352 may be included on the bottom body portion 340a (e.g., on the circumferential edge 346a as shown in FIG. 6), and the inlet air stream 332 may enter the air channel 348 therethrough and circulates through each of the body portions 340a-340c. In other examples, the body portions 340a-340c may be fluidly isolated from one another and each body portion may include a separate air flow opening for receiving a portion of the inlet air stream 332.

Each body portion 340a-340c includes outlet ports 350a-350c which are sized, shaped, and positioned to diffuse the inlet air stream 332 circulating through the air channel 348 into the saturated liquid desiccant 306, producing the diffused air stream 338. The outlet ports 350a-350c are located on the radial surface 342a-342c of the respective body portion 340a-340c. In some examples, one, some, or all the body portions 340a-340c may include outlet ports 350a-350c located on the radial surface 344a-344c and/or the circumferential edge 346a-346c. The outlet ports 350a-350c may have any suitable size, shape, and/or arrangement on the respective body portion 340a-340c, including those described above for the outlet ports 350 of the diffuser body 340. The outlet ports 350a-350c may be sized, shaped, and positioned to control (e.g., generate) turbulence in the diffused air stream 338, as described above for the outlet ports 350. Any description above of the outlet ports 350 applies to and may be implemented in the outlet ports 350a-350c of the body portions 340a-340c. In some examples, the outlet ports 350a on the bottom body portion 340a may be located on the radial surface 342a at locations that are radially beyond the circumferential edge 346b of the middle body portion 340b. Similarly, the outlet ports 350b on the middle body portion 340b may be located on the radial surface 342b at locations that are radially beyond the circumferential edge 346c of the top body portion 340c.

When the air diffuser 304 shown in FIG. 6 is operated in the regeneration tank 302, the body portions 340a-340c cooperate to define a tortuous desiccant flow path for the saturated liquid desiccant 306 that has desorbed moisture into the diffused air stream 338 and flows toward the desiccant outlet 316 as concentrated liquid desiccant 320. In particular, the liquid desiccant 306/320 flows both through a portion of the desiccant flow path formed by the axially aligned central passages 356a-356c, as well as a radially outer portion of the desiccant flow path formed around the circumferential edges of the top and middle body portions 340c and 340b. The radially-outward flowing liquid desiccant 306/320 then flows through the clearance defined between adjacent, spaced apart body portions 340a, 340b and 340b, 340c to converge with the liquid desiccant flowing through the axially aligned central passages 356a-356c. This tortuous desiccant flow path may facilitate greater turbulence and better mixing of the saturated liquid desiccant 306 and the diffused air stream 338. The multiple body portions 340a-340c may also facilitate increasing turbulence in the diffused air stream and/or greater distribution of the diffused air stream by increasing the number of outlet ports 350a-350c and/or providing more variance in the spatial relation of the outlet ports 350a-350c in the regeneration tank 302.

Referring again to FIG. 3, the liquid desiccant regeneration system 300 may include one or more heaters 358, 360, 362 that are operable to increase a vapor pressure differential between the saturated liquid desiccant 306 and the inlet air stream 332. The heaters 358, 360, 362 may be, or may be connected to. any suitable heat source, such as, for example, any one or more of a condenser fan or coil, hot fluid exiting a condenser, an inline heater, a boiler, a central hot water source, a waste heat source, and a hot water heater. Any combination or sub-combination of the example heaters 358-362 may be implemented.

A first example heater 358 that may be included in the system 300 is thermally connected to the regeneration tank 302. The first heater 358 operates to heat the saturated liquid desiccant 306 in the regeneration tank 302, thereby increasing the vapor pressure of the saturated liquid desiccant and facilitating greater desorption of moisture into the diffused air stream 338. The first heater 358 may include heating coils located within the regeneration tank 302 and/or a heating jacket that surrounds the regeneration tank 302. The first heater 358 may circulate a hot fluid (e.g., hot water or hot heat transfer fluid) for heating the saturated liquid desiccant 306. In some examples, the first heater 358 may be connected with the regenerator heat transfer loop 146 (shown in FIG. 1) and circulates heated regenerator heat transfer fluid 148 exiting the condenser 120, as described above for the heater 158.

A second example heater 360 that may be included in the system 300 is thermally connected on the inlet air supply line 330. The second heater 360 operates to heat the inlet air stream 332 before the inlet air stream enters the regeneration tank 302. The heated inlet air stream 332 may transfer heat to the saturated liquid desiccant 306 in the regeneration tank 302, thereby increasing the vapor pressure of the saturated liquid desiccant and facilitating greater desorption of moisture into the diffused air stream 338. In some examples, the second heater 360 may include the condenser coils 220 shown in FIG. 2, which may produce a heated, dry air stream that is subsequently channeled to the regeneration tank 302 as described above. The second heater 360 may additionally and/or alternatively include an inline heat exchanger, or any suitable heat exchanger or auxiliary heating source that facilitates heating the inlet air stream 332 upstream from the regeneration tank 302.

A third example heater 362 that may be included in the system 300 is thermally connected on the saturated desiccant line 314. The third heater 362 operates to heat the saturated liquid desiccant upstream from the regeneration tank 302, thereby increasing the vapor pressure of the saturated liquid desiccant and facilitating greater desorption of moisture into the diffused air stream 338. In some examples, the third heater 362 may include a desiccant-desiccant heat exchanger (e.g., the heat exchanger 156 shown in FIGS. 1 and 2) that facilitates transferring heat from the concentrated liquid desiccant 320 exiting the regeneration tank 302 to the saturated liquid desiccant 306 entering the regeneration tank 302. The third heater 362 may additionally and/or alternatively include an inline heat exchanger, any suitable heat exchanger that facilitates direct or indirect heat transfer between the concentrated liquid desiccant 320 and the saturated liquid desiccant 306, and/or another auxiliary heating source such as those described above.

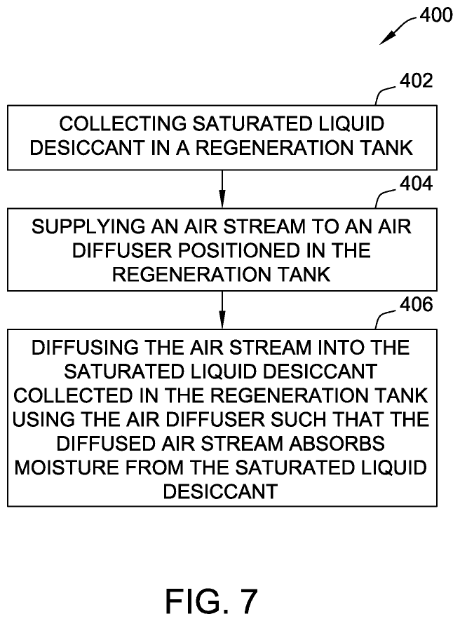

FIG. 7 is an example method 400 of operating a liquid desiccant regeneration system, such as the liquid desiccant regeneration system 300 shown in FIG. 3. The method 400 includes collecting 402 saturated liquid desiccant 306 in a regeneration tank 302. The saturated liquid desiccant 306 may be collected 402 in the regeneration tank 302 by channeling the saturated liquid desiccant to the regeneration tank via a saturated desiccant line 314 from another air treatment system operated in conjunction with the liquid desiccant regeneration system 300, such as a liquid desiccant dehumidification system (e.g., the conditioner sub-system 104 in FIGS. 1 and 2). The method 400 also includes supplying 404 an air stream (e.g., the inlet air stream 332) to an air diffuser 304 positioned in the regeneration tank 302. The method 400 may include heating the air stream 332 and/or the saturated liquid desiccant 306 upstream from the regeneration tank 302 and/or within the regeneration tank, such that the vapor pressure differential between the saturated liquid desiccant and the air stream increases to facilitate desorbing moisture from the saturated liquid desiccant into the air stream. The air stream 332 and/or the saturated liquid desiccant 306 may optionally be heated using one or more heaters (e.g., heaters 358, 360, 362 in FIG. 3). The method 400 also includes diffusing 406 the air stream 332 into the saturated liquid desiccant 306 collected 402 in the regeneration tank 302 using the air diffuser 304, such that the diffused air stream 338 absorbs moisture from the saturated liquid desiccant 306. Diffusing 406 the air stream 332 into the saturated liquid desiccant 306 may include generating turbulence in the diffused air stream 338 using the air diffuser 304. The method 400 may also include channeling concentrated liquid desiccant 320 through a passage 356 defined by the air diffuser 304 towards a desiccant outlet 316 of the regeneration tank 302. The method 400 may also include channeling the concentrated liquid desiccant 320 exiting the regeneration tank 302 via the desiccant outlet 316 back to the liquid desiccant dehumidification system (e.g., the conditioner sub-system 104 in FIGS. 1 and 2).

Example HVAC systems described include a liquid desiccant regeneration system for transferring moisture from saturated liquid desiccant into an air stream to produce concentrated liquid desiccant that may be re-routed to a dehumidification system. The liquid desiccant regeneration system includes one or more regeneration tanks for collecting saturated liquid desiccant and an air diffuser positioned in each regeneration tank. The air diffuser operates to diffuse an air stream into the saturated liquid desiccant. The diffused air stream constitutes air bubbles that are distributed throughout the volume of saturated liquid desiccant and flow through the saturated liquid desiccant, providing a large amount of surface area contact between the air stream and the saturated liquid desiccant. This facilitates optimizing the amount of moisture absorbed from the saturated liquid desiccant. The air diffuser may also generate turbulence in the diffused air stream, further enhancing moisture transfer. The liquid desiccant regeneration system may also include one or more heaters that operate to increase the vapor pressure of the saturated liquid desiccant and facilitate greater desorption of moisture into the diffused air stream. The liquid desiccant regeneration system may facilitate reducing the size and overall footprint of the liquid desiccant regenerator, and also reduce manufacturing, installation, and/or operating costs. The liquid desiccant regeneration system may also facilitate regenerating liquid desiccant during off-peak hours of the HVAC system, thus reducing energy costs and improving system efficiency.

Example embodiments of HVAC systems and methods of operating the systems are described above in detail. The systems and methods are not limited to the specific embodiments described herein, but rather, components of the system and methods may be used independently and separately from other components described herein. For example, the systems described herein may be used in systems other than HVAC systems.

When introducing elements of the present disclosure or the embodiment(s) thereof, the articles “a”, “an”, “the” and “said” are intended to mean that there are one or more of the elements. The terms “comprising,” “including,” “containing” and “having” are intended to be inclusive and mean that there may be additional elements other than the listed elements. The use of terms indicating a particular orientation (e.g., “top”, “bottom”, “side”, “vertical”, “lateral”, “longitudinal”, etc.) is for convenience of description and does not require any particular orientation of the item described.

The terms “about,” “substantially,” “essentially” and “approximately,” and their equivalents, when used in conjunction with ranges of dimensions, concentrations, temperatures or other physical or chemical properties or characteristics is meant to cover variations that may exist in the upper and/or lower limits of the ranges of the properties or characteristics, including, for example, variations resulting from rounding, measurement methodology or other statistical variation.

As various changes could be made in the above constructions and methods without departing from the scope of the disclosure, all matter contained in the above description and shown in the accompanying drawing(s) shall be interpreted as illustrative and not in a limiting sense.

What is claimed is:

1. A liquid desiccant regeneration system comprising:
a regeneration tank for containing saturated liquid desiccant, the regeneration tank having an air inlet, a desiccant inlet, and a desiccant outlet; and
an air diffuser positioned within the regeneration tank between the desiccant inlet and the desiccant outlet, wherein the air diffuser is operable to receive an air stream from the air inlet and diffuse the air stream into the saturated liquid desiccant contained in the regeneration tank.

2. The liquid desiccant regeneration system of claim 1, wherein the air diffuser has a diffuser body defining an air channel for circulating the air stream received from the air inlet, and outlet ports defined in the diffuser body to diffuse the air stream into the saturated liquid desiccant.

3. The liquid desiccant regeneration system of claim 2, wherein the outlet ports are sized, shaped, and positioned such that the air diffuser is operable to generate turbulence in the air stream diffused into the saturated liquid desiccant.

4. The liquid desiccant regeneration system of claim 2, wherein the diffuser body has an annular shape.

5. The liquid desiccant regeneration system of claim 4, wherein the diffuser body defines a passage that forms a desiccant flow path between the desiccant inlet and the desiccant outlet.

6. The liquid desiccant regeneration system of claim 5, wherein the outlet ports defined in the diffuser body are in one of a circular pattern and a spiral pattern about the passage.

7. The liquid desiccant regeneration system of claim 2, wherein the diffuser body includes multiple body portions that cooperate to define a tortuous desiccant flow path between the desiccant inlet and the desiccant outlet.

8. The liquid desiccant regeneration system of claim 1, wherein the regeneration tank has an air outlet located vertically above the air inlet, wherein the air diffuser is positioned between the air inlet and the air outlet.

9. A heating, ventilation, and air conditioning (HVAC) system comprising:
a dehumidification sub-system operable to transfer moisture between a liquid desiccant and a first air stream; and
a regeneration sub-system operable to transfer moisture between the liquid desiccant and a second air stream, wherein the HVAC system is operable to circulate concentrated liquid desiccant to the dehumidification sub-system and saturated liquid desiccant to the regeneration sub-system, wherein the regeneration sub-system comprises:
a regeneration tank for containing the saturated liquid desiccant, the regeneration tank having an air inlet, a desiccant inlet, and a desiccant outlet; and
an air diffuser positioned within the regeneration tank between the desiccant inlet and the desiccant outlet, wherein the air diffuser is operable to receive the second air stream from the air inlet and diffuse the second air stream into the saturated liquid desiccant contained in the regeneration tank.

10. The HVAC system of claim 9, wherein the HVAC system is operable to increase a vapor pressure differential between the saturated liquid desiccant and the second air stream.

11. The HVAC system of claim 10, further comprising a heater operable to increase the vapor pressure differential between the saturated liquid desiccant and the second air stream.

12. The HVAC system of claim 11, wherein the heater comprises at least one of heating coils, a heating jacket, a condenser fan, an inline heater, a boiler, a central hot water source, a waste heat source, and a hot water heater.

13. The HVAC system of claim 11, wherein the heater is thermally connected to the regeneration tank to heat the saturated liquid desiccant within the regeneration tank.

14. The HVAC system of claim 9, wherein the air diffuser has a diffuser body defining an air channel for circulating the second air stream received from the air inlet, and outlet ports defined in the diffuser body to diffuse the second air stream into the saturated liquid desiccant contained in the regeneration tank.

15. The HVAC system of claim 14, wherein the outlet ports are sized, shaped, and positioned such that the air diffuser is operable to generate turbulence in the second air stream diffused into the saturated liquid desiccant.

16. The HVAC system of claim 14, wherein the diffuser body defines a passage that forms a desiccant flow path between the desiccant inlet and the desiccant outlet.

17. A method of operating a liquid desiccant regeneration system, the method comprising:
collecting saturated liquid desiccant in a regeneration tank;
supplying an air stream to an air diffuser positioned in the regeneration tank; and
diffusing the air stream into the saturated liquid desiccant collected in the regeneration tank using the air diffuser such that the diffused air stream absorbs moisture from the saturated liquid desiccant.

18. The method of claim 17, further comprising heating at least one of the air stream supplied to the air diffuser and the saturated liquid desiccant collected in the regeneration tank to increase a vapor pressure differential between the saturated liquid desiccant and the air stream.

19. The method of claim 17, wherein diffusing the air stream into the saturated liquid desiccant comprises generating turbulence in the air stream diffused into the saturated liquid desiccant using the air diffuser.

20. The method of claim 17, further comprising channeling concentrated liquid desiccant through a passage defined by the air diffuser towards a desiccant outlet of the regeneration tank.
